(19) United States
(12) Patent Application Publication
(10) Pub. No.: US 2010/0026124 A1
(43) Pub. Date: Feb. 4, 2010

(54) Rotor for brushless motor

(76) Inventor: Yi-Tang Lu, Shengkang Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,961

(22) Filed: Jul. 31, 2008

(51) Int. Cl. H02K 1/28

(52) U.S. Cl. 310/156.12

(57) ABSTRACT

A rotor for brushless motor is disclosed to use locating blocks for securing magnetic plates to peripheral flanges of silicon steel plates being arranged in a stack and sleeved onto a shaft and weight(s) for insertion into peripheral notches of the silicon steel plates to adjust the center of gravity and to keep the rotor in balance.

### BACKGROUND OF THE INVENTION

1. Field of the Invention

The present invention relates to a motor and more particularly, to a rotor for brushless motor, which produces a great horsepower and reduces the vibration effect.

2. Description of the Related Art

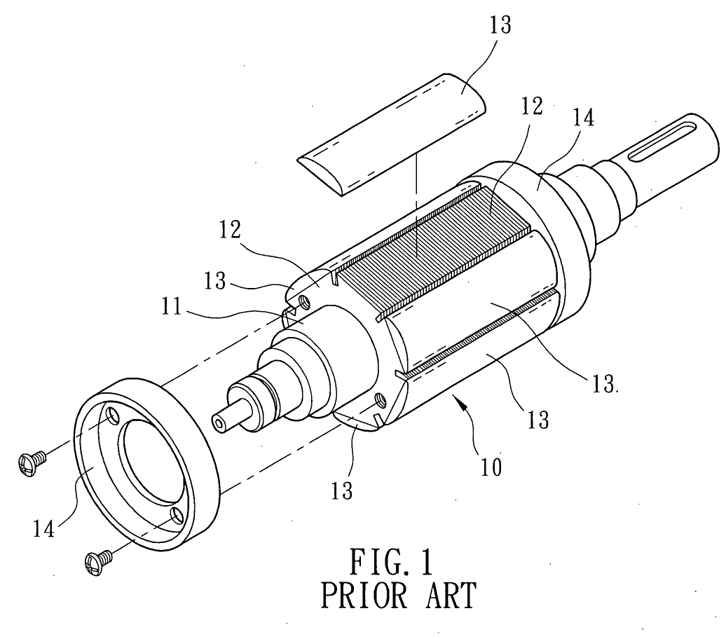

A motor is generally comprised of a rotor, and a stator with a winding. When the winding is electrically connected, a magnetic field is produced to bias the rotor. A conventional rotor 10 for brushless motor, as shown in FIGS. 1˜3, comprises a shaft 11, a stack of silicon steel plates 12 sleeved onto the shaft 11, a plurality of magnetic plates 13 respectively covered on the polar protrusions of the silicon steel plates 12, and end caps 14 sleeved onto the shaft 11 and secured to two opposite sides of the stack of silicon steel plates 12.

This design of rotor still has drawbacks as follows:

1. The magnetic plates 13 are respectively bonded to the silicon steel plates 12 with an adhesive. After a long use, the adhesive will be aged, resulting in dropping of the magnetic plates 13 from the silicon steel plates 12.

2. When the magnetic plates 13 and the silicon steel plates 12 are bonded together, there is no gap in the assembly of magnetic plates 13 and the silicon steel plates 12 for ventilation, resulting in low heat dissipation efficiency of the rotor 10.

3. If the center of gravity is not accurately located on the geometrical center after the rotor 10 has been assembled, the position of the center of gravity of the rotor 10 is not adjustable, and the rotor 10 may be unstable during operation.

### SUMMARY OF THE INVENTION

The present invention has been accomplished under the circumstances in view. It is therefore one object of the present invention to provide a rotor for brushless motor, which allows adjustment of the position of the center of gravity. It is another object of the present invention to provide a rotor for brushless motor, which facilitates circulation of air for quick dissipation of waste heat.

To achieve these and other objects of the present invention, the rotor comprises a shaft; a plurality of silicon steel plates arranged in a stack and sleeved onto the shaft, each silicon steel plate comprising a plurality of peripheral notches and peripheral flanges alternatively and equiangularly spaced around the periphery thereof; a plurality of magnetic plates respectively attached to the peripheral flanges of the silicon steel plates and arranged in parallel around the shaft; a plurality of locating blocks respectively inserted into the periphery notches of the silicon steel plates to secure the magnetic plates to the silicon steel plates; counterweight means selectively inserted into the peripheral notches of the silicon steel plates to adjust the center of gravity of the rotor; and two end caps sleeved onto the shaft to secure the silicon steel plates to the shaft.

### DESCRIPTION OF THE RELATED ART

FIG. 1 is an exploded view of a rotor for brushless motor according to the prior art.

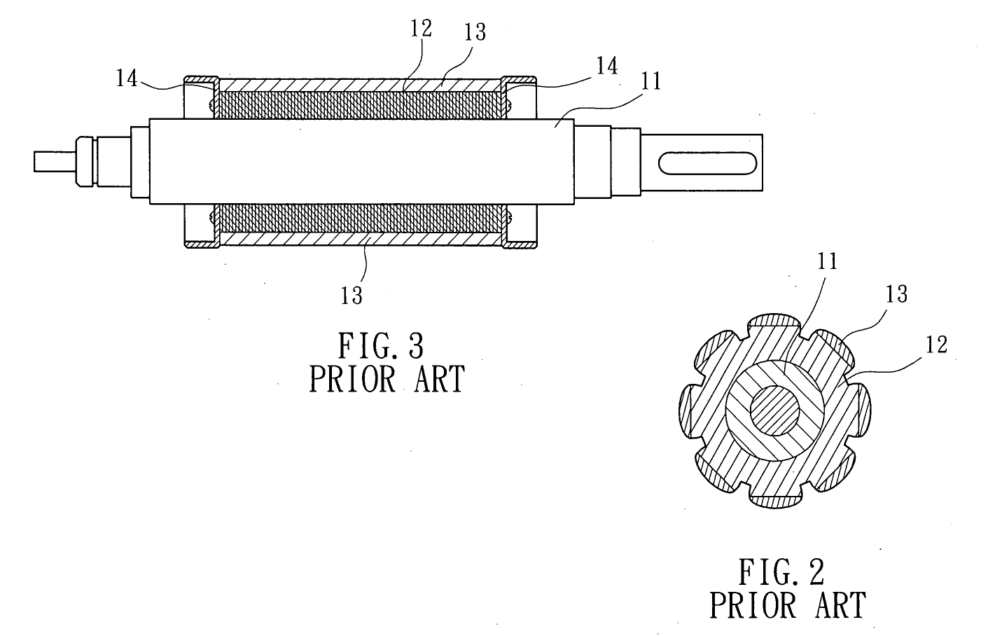

FIG. 2 is a cross-sectional view of the rotor for brushless motor according to the prior art.

FIG. 3 is a sectional side view of the rotor for brushless motor according to the prior art.

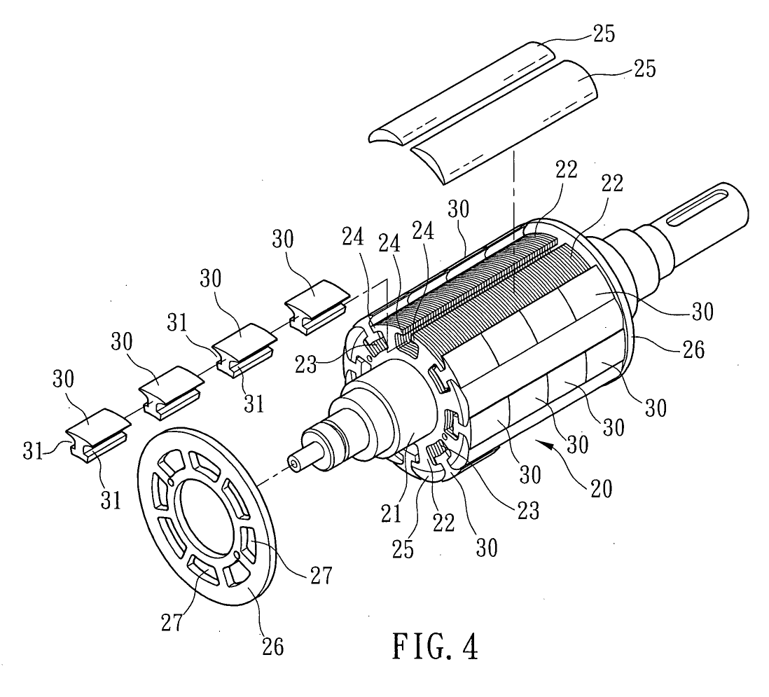

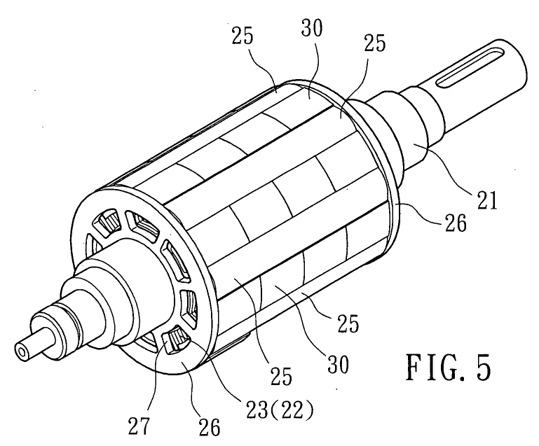

FIG. 4 is an exploded view of a rotor for brushless motor according to the present invention.

FIG. 5 is an elevational assembly view of the rotor for brushless motor according to the present invention.

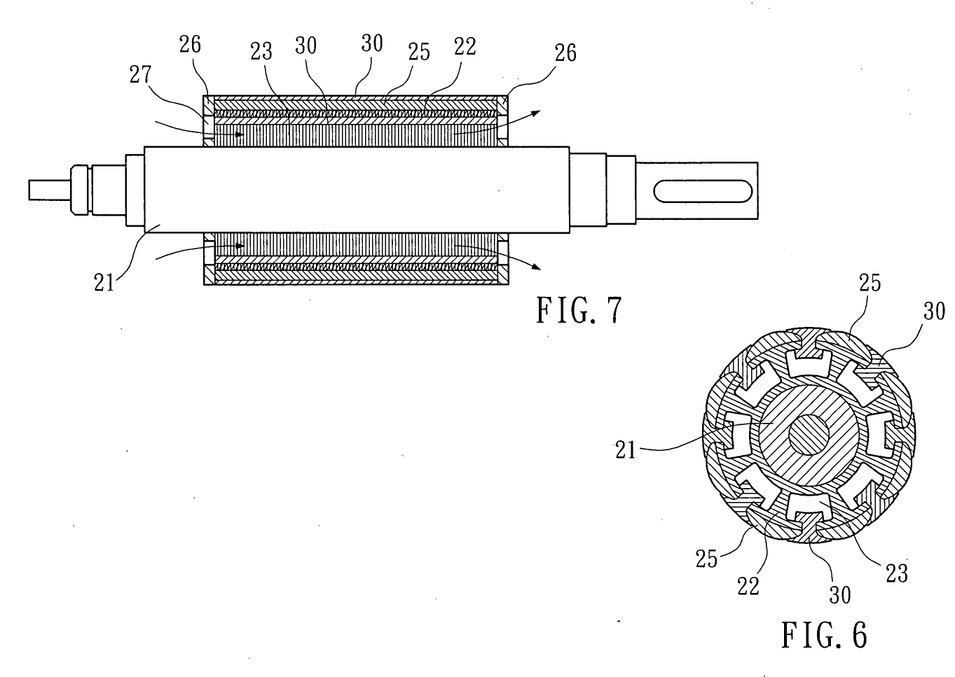

FIG. 6 is a cross-sectional view of the rotor for brushless motor according to the present invention.

FIG. 7 is a sectional side view of the rotor for brushless motor according to the present invention.

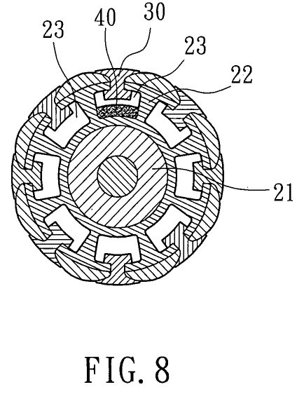

FIG. 8 corresponding to FIG. 6, showing a weight set in the peripheral notches of the silicon steel plates.

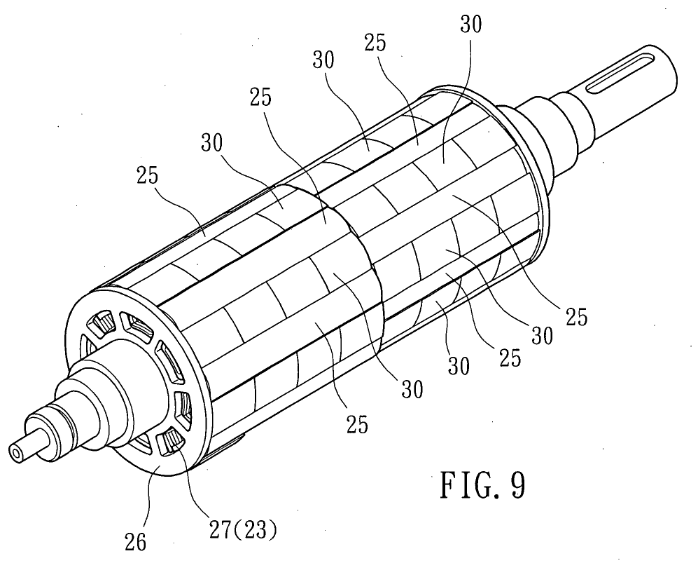

FIG. 9 is an elevational assembly view of an alternate form of the rotor for brushless motor according to the present invention.

### DETAILED DESCRIPTION OF THE PREFERRED EMBODIMENT

Referring to FIGS. 4˜8, a rotor 20 in accordance with the present invention is shown comprised of a shaft 21, a stack of silicon steel plates 22 sleeved onto the shaft 21, a plurality of magnetic plates 25 respectively covered on the silicon steel plates 22, and end caps 26 sleeved onto the shaft 21 and secured to two opposite sides of the stack of silicon steel plates 22. Each silicon steel plate 22 has a plurality of peripheral notches 23 and peripheral flanges 24 alternatively and equiangularly arranged around the periphery. The magnetic plates 25 are respectively attached to the peripheral flanges 24 of the silicon steel plates 22 and arranged in a parallel manner around the shaft 21.

Further, a plurality of locating blocks 30 are respectively mounted in the peripheral notches 23 of the silicon steel plates 22 and arranged in multiple series around the shaft 21 to secure the magnetic plates 25 to the peripheral flanges 24 of the silicon steel plates 22. Each locating block 30 has two locating grooves 31 symmetrically disposed at two opposite lateral sides for insertion into one peripheral notch 23 of each of the silicon steel plates 22 and coupling to the corresponding peripheral flanges 24 of the silicon steel plates 22.

Further, a weight or weights 40 may be selectively inserted into the peripheral notches 23 of the silicon steel plates 22 (see FIG. 8) to adjust the position of the center of gravity, keeping the rotor 20 in balance. Further, each end cap 26 has a plurality of air holes 27 corresponding to the peripheral notches 23 of the silicon steel plates 22 for guiding currents of air through the peripheral notches 23 of the silicon steel plates 22 for quick dissipation of waste heat.

Referring to FIGS. 4 and 6 again, each peripheral notch 23 of each silicon steel plate 22 has an inverted-C configuration defined between two adjacent peripheral flanges 24 of the respective silicon steel plates 22. Further, the locating blocks 30 have a substantially I-shaped cross section. When inserting the locating blocks 30 into the peripheral notches 23 of the silicon steel plates 22, the locating grooves 31 of the locating blocks 30 are respectively forced into engagement with the respective peripheral flanges 24 of the respective silicon steel plates 22 and the respective magnetic plates 25, thereby securing the respective magnetic plates 25 to the respective silicon steel plates 22 firmly. Therefore, it is not necessary to apply an adhesive to the magnetic plates 25 and/or the peripheral flanges 24 of the respective silicon steel plates 22 for bonding the magnetic plates 25 to the respective silicon steel plates 22.

Subject to the aforesaid arrangement, the rotor 20 further the advantages as follows:

1. If the center of gravity of the rotor 20 is biased toward one side, one weight 40 or a number of weights 40 can be inserted into the peripheral notches 23 of the silicon steel plates 22 to adjust the center of gravity of the rotor 20 to the geometrical center of the rotor 20 (as shown in FIG. 8), keeping the rotor 20 in balance and avoiding vibration or noises during operation of the rotor 20.

2. As shown in FIG. 7, each end cap 26 has a plurality of air holes 27 corresponding to the peripheral notches 23 of the silicon steel plates 22 for guiding currents of air through the peripheral notches 23 of the silicon steel plates 22 for quick dissipation of waste heat.

FIG. 8 shows an alternate form of the present invention. This alternate form is substantially similar to the embodiment shown in FIGS. 4˜8 with the exception that this alternate form has two sets of silicon steel plates and magnetic plates arranged on one common shaft, and the magnetic plates of the first set are respectively biased from that of the second set.

Although particular embodiment of the invention have been described in detail for purposes of illustration, various modifications and enhancements may be made without departing from the spirit and scope of the invention. Accordingly, the invention is not to be limited except as by the appended claims.

1. A rotor for use in a bnishless motor, comprising:
a shaft;
a plurality of silicon steel plates arranged in a stack and sleeved onto said shaft, each said silicon steel plate comprising a plurality of peripheral notches and peripheral flanges alternatively and equiangularly spaced around the periphery thereof;
a plurality of magnetic plates respectively attached to the peripheral flanges of said silicon steel plates and arranged in parallel around said shaft;
a plurality of locating blocks each defining an I-contour cross section having an upper block base member and a lower block base member, said lower block base member being respectively inserted into the periphery notches of said silicon steel plates and said upper block base member overlapping an upper surface of said magnetic plate to secure said magnetic plates to said silicon steel plates;
weight means selectively inserted into the peripheral notches of said silicon steel plates to adjust the center of gravity of the rotor; and
two end caps sleeved onto said shaft to secure said silicon steel plates to said shaft

2. The rotor as claimed in claim 1, wherein each end cap has a plurality of air holes corresponding to the peripheral notches of said silicon steel plates for guiding currents of air through the peripheral notches of said silicon steel plates.
